(19) United States
(12) Patent Application Publication
(10) Pub. No.: US 2017/0123649 A1
(43) Pub. Date: May 4, 2017

(54) Remote Desktop Controlled by Touch Device

(71) Applicant: Rabbit, Inc., Redwood City, CA (US)

(72) Inventors: Philippe Clavel, San Francisco, CA (US); Bogdan Alexandru Dinulica, Redwood City, CA (US); Cathrine Lindblom Gunasekara, Redwood City, CA (US); Kevin Joseph Cassidy, JR., Redwood City, CA (US)

(21) Appl. No.: 15/336,452

(22) Filed: Oct. 27, 2016

Related U.S. Application Data
(60) Provisional application No. 62/247,677, filed on Oct. 28, 2015.

(51) Int. Cl. G06F 3/0488; G06F 3/0485; G06F 3/0481; G06F 3/14

(52) U.S. Cl. CPC G06F 3/04883; G06F 3/1454; G06F 3/0485; G06F 3/04817; G06F 2203/04808; G06F 2203/04803; H04L 67/12

(57) ABSTRACT

In one embodiment, a method may include receiving a request by an electronic device to access a computing device associated with a virtual-room at a virtual-room service system. The method may include establishing a communication session between the electronic device and the computing device on behalf of the request. The method may then include receiving a user input at an electronic device, the user input comprising a touch input to control the computing device associated with the virtual room and sending a content to an interactive display screen of the electronic device based on the touch input.

### PRIORITY

This application claims the benefit, under 35 U.S.C.§119(e), of U.S. Provisional Patent Application No. 62/247,677, filed 28 Oct. 2015, which is incorporated herein by reference.

### TECHNICAL FIELD

This disclosure generally relates to controlling a remote desktop.

### SUMMARY OF PARTICULAR EMBODIMENTS

In particular embodiments, a user may control a remote computer through use of a touch screen, despite the remote desktop having no touch input controls. In particular embodiments, a user of a touch device may control a mouse cursor (e.g., move, click, etc.), scroll, select objects, zoom in our out, or perform any other suitable actions on a remote non-touch device.

### BRIEF DESCRIPTION OF THE DRAWINGS

FIG. 1 illustrates an example network environment associated with room service networking system.

FIG. 2A illustrates an example of remotely controlling a mouse cursor from a remote device.

FIG. 2B illustrates an example of remotely using a mouse cursor with a second icon.

FIG. 2C illustrates an example of selecting objects using a remote mouse cursor from a touch device.

FIG. 2D illustrates an example of selecting an object from a remote device with a touch input.

FIG. 2E illustrates another example of remotely using a mouse cursor.

FIG. 2F illustrates another example of selecting an object with a touch input.

FIG. 2G illustrates an example user interface.

FIG. 3A illustrates an example of zooming in on a touch device to remotely control a device.

FIG. 3B illustrate an example of zooming out on a touch device to remotely control a device.

FIG. 3C illustrates another example of remotely using a mouse cursor.

FIG. 4 illustrates yet another example of remotely using a mouse cursor while zooming in or out.

FIGS. 5A-B illustrates an example of scrolling on a touch device to scroll on a remote device.

FIG. 6 illustrates an example computer system.

### DESCRIPTION OF EXAMPLE EMBODIMENTS

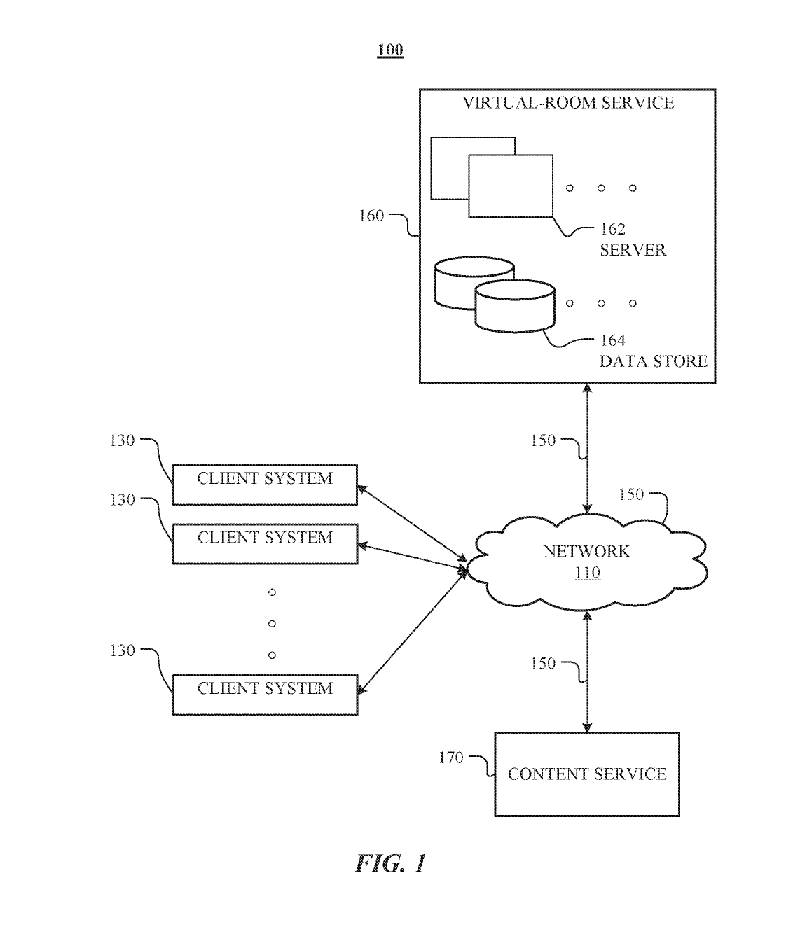

FIG. 1 illustrates an example network environment 100 associated with a virtual-room service 160. Network environment 100 includes multiple client systems 130, virtual-room service 160, and at least one content system 170 connected to each other by a network 110. Although FIG. 1 illustrates a particular arrangement of particular systems, this disclosure contemplates any suitable arrangement of any suitable systems. As an example and not by way of limitation, network environment 100 may include multiple server systems 160. As another example, network environment 100 may include multiple third-party systems 170. As another example, server system 160 may be physically or logically co-located with each other in whole or in part. Moreover, although FIG. 1 illustrates a particular number of client systems 130, server systems 160, third-party systems 170, and networks 110, this disclosure contemplates any suitable number of client systems 130, server systems 160, third-party systems 170, and networks 110. As an example and not by way of limitation, network environment 100 may include multiple client system 130, room service systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

In particular embodiments, FIG. 1 may illustrate a method for hosting a virtual-room service 160 between a plurality of client systems 130, sending room information from virtual-room service 160 from a server 162 and/or data store 164 to one or more client systems 130 over network 110 which may contain third party content from content service 170. As examples only, and not by way of limitation, the following are examples of content services 170 in particular embodiments: YOUTUBE, NETFLIX, FACEBOOK, SPOTIFY, websites, web pages, HBO GO, SHOWTIME ANYTIME, or any other similar service.

In particular embodiments, virtual-room service 160 may host a “room” for multiple participants to view information from content service 170. In particular embodiments, the room is a virtual room where tens, hundreds, thousands, or millions of users may participate with each other. In further embodiments, each room may be assigned a remote desktop (e.g. server) of virtual-room service 160. In further embodiments, each remote desktop may be controlled by one user in each of the rooms. In particular embodiments, multiple users may control the remote desktop of virtual-room service 160.

In particular embodiments, client system 130 may access virtual-room service 160 over network 150 to obtain access to a remote desktop (e.g. server). In particular embodiments, upon accessing a remote desktop, client system 130 may use the accessed remote desktop as their own. For example, and not by way of limitation, upon accessing the remote desktop, client system 130 may use the remote desktop to access YOUTUBE or NETFLIX and begin streaming content. In particular embodiments, multiple client systems 130 may be connected to the same room with the user who accessed the remote desktop. In particular embodiments, all of client systems 130 in the same room may simultaneously view the content the owner of the room has accessed. In particular embodiments, server 162 may send the audio and video content of each client system 130 in the room to all of the other client systems 130 in the room. In particular embodiments, data store 164 may track any and all activity that occurs within the room, such as users preferences, the information content service 170 has provided, or any other pertinent information.

In particular embodiments, client system 130 may receive other participants audio and/or video streams whom are also in the room. In particular embodiments, virtual-room service 160 sends the participants audio and/or video streams to the other participant's client systems 130 who are in the room. In particular embodiments, such system may enable users within a room to stream the respective audio and video streams to different remote desktops located within virtual-room service 160 and to track the associations, user preferences, etc. and store such information in data store 164.

In particular embodiments, receiving audio and video streams from a remote desktop (e.g. server) may include capturing the audio and video streams from the client systems 130, sending the audio and video streams to server 162, and subsequently sending the streams to all client systems in the room. In particular embodiments, capturing the audio and video streams may include capturing information from client systems 130 microphone and camera. In particular embodiments, the captured streams may include content streamed from content service 170. As an example and not by way of limitation, the captured stream may include content streamed from a YOUTUBE video.

Links 150 may connect client system 130, room service networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, room service networking system 160 may be a network-addressable computing system that can host an online social network. Room service networking system 160 may generate, store, receive, and send social-networking data, such as, for example, user-profile data, concept-profile data, social-graph information, or other suitable data related to the online social network. Room service networking system 160 may be accessed by the other components of network environment 100 either directly or via network 110. As an example and not by way of limitation, client system 130 may access room service networking system 160 using a web browser 132, or a native application associated with room service networking system 160 (e.g., a mobile social-networking application, a messaging application, another suitable application, or any combination thereof) either directly or via network 110. In particular embodiments, room service networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, room service networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, room service networking system 160 may provide users with the ability to take actions on various types of items or objects, supported by social-networking system 160. In particular embodiments, room service networking system 160 may provide users with the ability to view information from content service 170 without client system initiating their own room. In particular embodiments, room service networking system 160 may determine certain information to display from content service 170 at a predetermined time and invite users to join an already existing room. For example, every Friday at 7:00 pm the system may stream a horror movie and the system may provide a notice to users that Friday at 7:00 pm a horror movie will be streamed. In further embodiments, upon logging in to the service, if the horror movie has already begun, the system may provide a notification to the user to join the Friday horror room. As another example and not by way of limitation, the items and objects may include groups or social networks to which users of room service networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in room service networking system 160 or by an external system of third-party system 170, which is separate from room service networking system 160 and coupled to room service networking system 160 via a network 110.

In particular embodiments, room service networking system 160 may be capable of linking a variety of entities. As an example and not by way of limitation, room service networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, room service networking system 160 and third-party systems 170 may operate in conjunction with each other to provide social-networking services to users of room service networking system 160 or third-party systems 170. In this sense, room service networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, room service networking system 160 also includes user-generated content objects, which may enhance a user's interactions with social-networking system 160. User-generated content may include anything a user can add, upload, send, or “post” to social-networking system 160. As an example and not by way of limitation, a user communicates posts to room service networking system 160 from a client system 130. Posts may include data such as status updates or other textual data, location information, photos, videos, links, music or other similar data or media. Content may also be added to room service networking system 160 by a third-party through a “communication channel,” such as a newsfeed or stream.

In particular embodiments, room service networking system 160 may include a variety of servers, sub-systems, programs, modules, logs, and data stores. In particular embodiments, room service networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Room service networking system 160 may also include suitable components such as network interfaces, security mechanisms, load balancers, failover servers, management-and-network-operations consoles, other suitable components, or any suitable combination thereof. In particular embodiments, room service networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories.

A web server may be used for linking room service networking system 160 to one or more client systems 130 or one or more third-party system 170 via network 110. An API-request server may allow a third-party system 170 to access information from room service networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by room service networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

In particular embodiments, a first computing device may access a second computing device using a remote desktop service. A connection is initiated on the second computing device to connect to the first computing device and a remote desktop client may be initiated on the second computer. A request may then be created for a remote desktop protocol session with the first computing device using an operating environment where the operating environment obtains its settings from an operating environment configuration file. In particular embodiments, the request may be communicated through a cloud service to the first computing device. In further embodiments, an authorization is received to begin the desktop protocol session from a remote desktop server application on the first computing device through the cloud service and a channel is established from the second computing device to the first computing device through the cloud service. Remote desktop protocol data flow begins from the first computer to the second computer through the cloud services where a second computer display and operating system experience is virtually the same as a first computer and all operations on the first computer are available on the second computer by using the second computer display.

For example, a request for a remote desktop protocol session with the first computing device may be created using a particular operating environment. The operating environment may be spread over a network and parts, which may be spread over the network and may be accessed from the various network nodes as needed. In further embodiments, other nodes in the operating system may access different parts of the operating environment from an of the nodes on the network.

In particular embodiments, the request for a remote desktop protocol session may be communicated through a cloud service to the computing device. The cloud service may represent a service or application that controls data through a widely dispersed network, such as the internet. The response to the request may be handed in any number of ways known in the art. In particular embodiments, a display is created on the first computing device where a user may select to allow a user to remotely control the first computing device. In another embodiment, the first computing device has a list of acceptable second computing devices that have standing permission to remotely access the first computing device.

In particular embodiments, an authorization step may occur where the desktop protocol session from a remote desktop server application may be received on the first computing device through the cloud service. In further embodiments, the first computing device may be a node in the network cloud and may receive the request of a remote connection.

In further embodiments, a channel may be established from the second computing device to the first computing device through the cloud server. Assuming permission was granted, a channel may then be created. In particular embodiments, the channel may be created using SSL or through any other appropriate technology known in the art.

In particular embodiments, a remote desktop protocol data flow may being from the first computing device to the second computing device through the cloud services. In further embodiments, as a result, the second computing device display may be virtually the same as the first computing device display. In particular embodiments, any operation on the first computing device may be available on the second computing device by using the second computing device display. The display may be a copy of the graphical elements of the first display making the display on the second computing device to be viewed as virtually exact as the first display.

In particular embodiments, in order to for the computing device to be remotely accessed, the first computing device may have to register with a remote access gateway. In particular embodiments, the registration may take a variety of forms and use hardware or software applications.

In particular embodiments, a user remotely accessing a second computing device may access such device by use of a touch screen or similar device. For example, a user may access a remote desktop through a cellphone, PDA, television, touch screen device, or any other suitable device, however such device may not have the standard mouse and keyboard configuration. In particular embodiments, a user may still navigate the remote device by use of a touch screen or any other means even though the user's device does not have matching means of navigation.

In particular embodiments, a display device may include a user interface (UI) displayed on screen and connected to the processor. The screen may be configured to display text, digital images, or video. The screen may be configured to be user interactive (e.g., recognize and accept user inputs to interact with device software). The screen may include any suitable type of display, for example, an electrophoretic display, a liquid crystal display (LCD), a light-emitting diode (LED) display, an organic light-emitting diode (OLED) display, an organic field-effect transistor (OFET) display, or other suitable display. This disclosure contemplates any suitable type of display configured to be user interactive. In particular embodiments, the screen may be a touch screen and able to receive gestures from a user. In particular embodiments, the gesture may include a single-touch interaction or a multi-touch interaction.

In particular embodiments a remote desktop protocol, or any other suitable method known in the art, may be used for video conferencing between a plurality of participants. In particular embodiments the video conferencing may include sending conversation group information from a managing server (or remote desktop) to a second device. In particular embodiments, a managing server (or remote desktop, server, etc.) may send multiple participants audio and video streams to a set of user devices. In particular embodiments, this may allow users within a group to stream a certain audio clip, view web content, or simply use a remote desktop as a group of individuals. In particular embodiments, one group user holds the “remote” and has “control” over the remote desktop. In particular embodiments, the user with the “remote” is able to choose or select content for the group of participants to view. In particular embodiments, such methods may facilitate video conferring, video chatting, or any other suitable audio-video communications between a plurality of users. In particular embodiments, the user holding the “remote control” may control the remote desktop by a touch screen. In particular embodiments, the user controlling the “remote control” may use an electronic device, such as a cellphone with a touch screen, to control a remote desktop. In particular embodiments, the user's device may be a touch screen device, however the remote desktop may not be a touch screen device. In particular embodiments, a touch screen device may have controls to control a remote non-touch screen device.

In particular embodiments, each group of participants may be assigned to a particular remote desktop, server, etc. for their current session. In further embodiments, the group of participants may be assigned to different devices. In further embodiments, there may be hundreds, thousands, millions, or billions of chat room or groups in which a user may join. In further embodiments, each “room” where a user or groups of users enter may support audio and/or video sharing between an unlimited number of participants. In particular embodiments, each room may contain one or more “remote controls.” In particular embodiments, there may be one remote per room. In particular embodiments, the remote allows a user to determine what the others in the room will be watching, just as a TV remote allows the user to change channels. In particular embodiments, the user with the remote, the controlling user, is the user responsible for choosing content to display to the others in the room. In particular embodiments, the users in a room view the content the user holding the “remote control” has selected for viewing. In particular embodiments, the remote may be passed from user to user so that one person may hold the remote at a time. In particular embodiments, the remote desktop just as the display device may be configured to receive and recognize specific user gestures and input as described below.

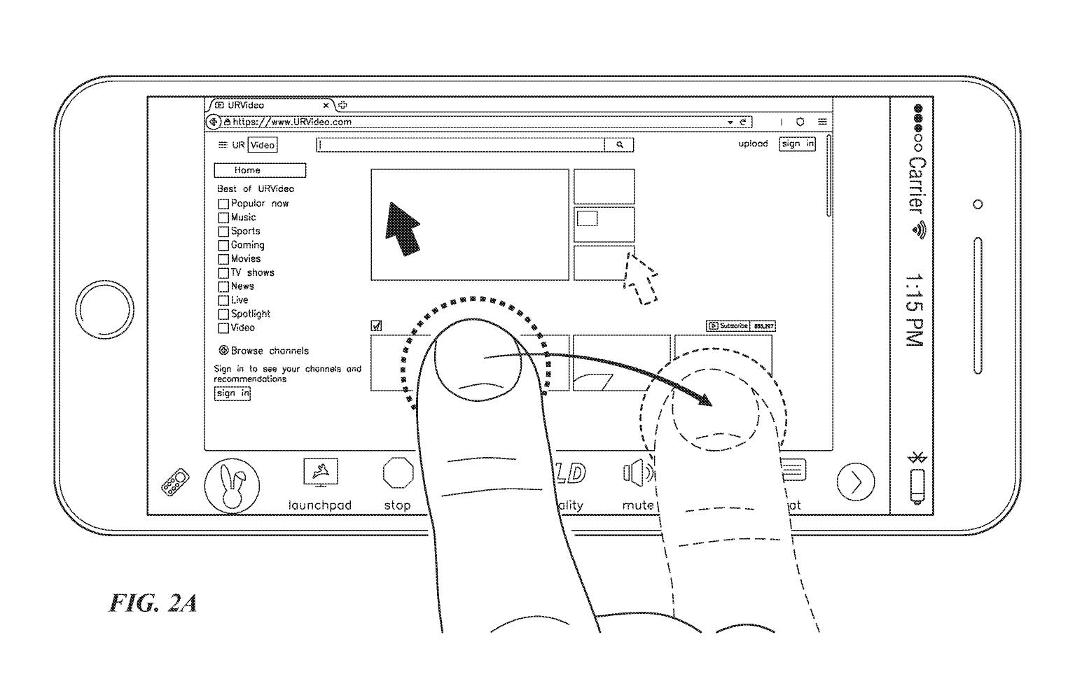

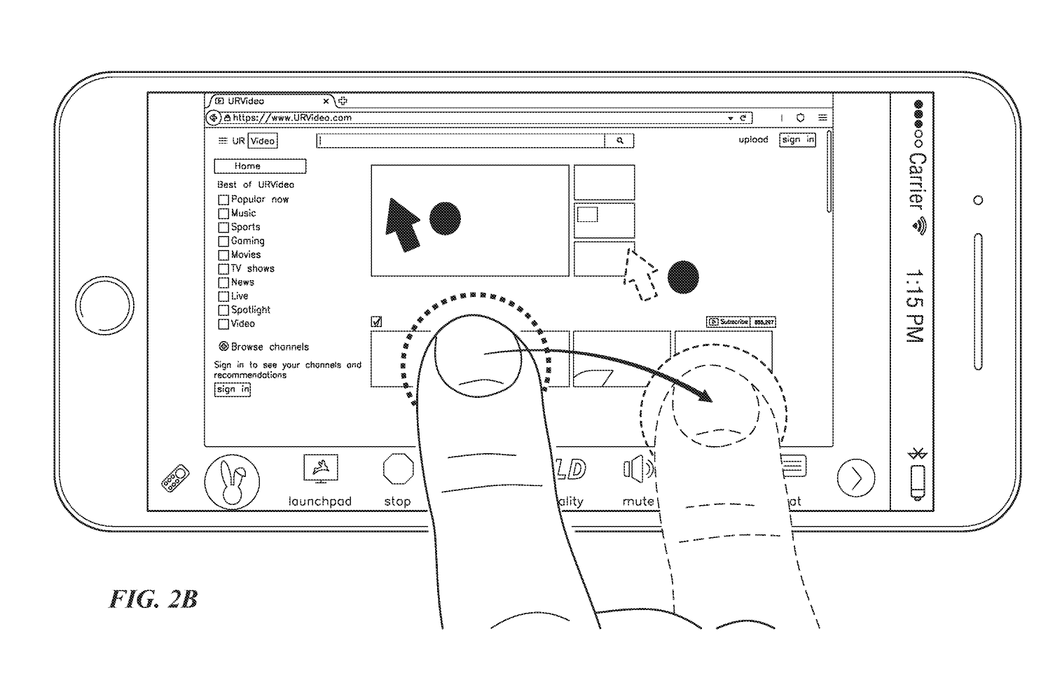

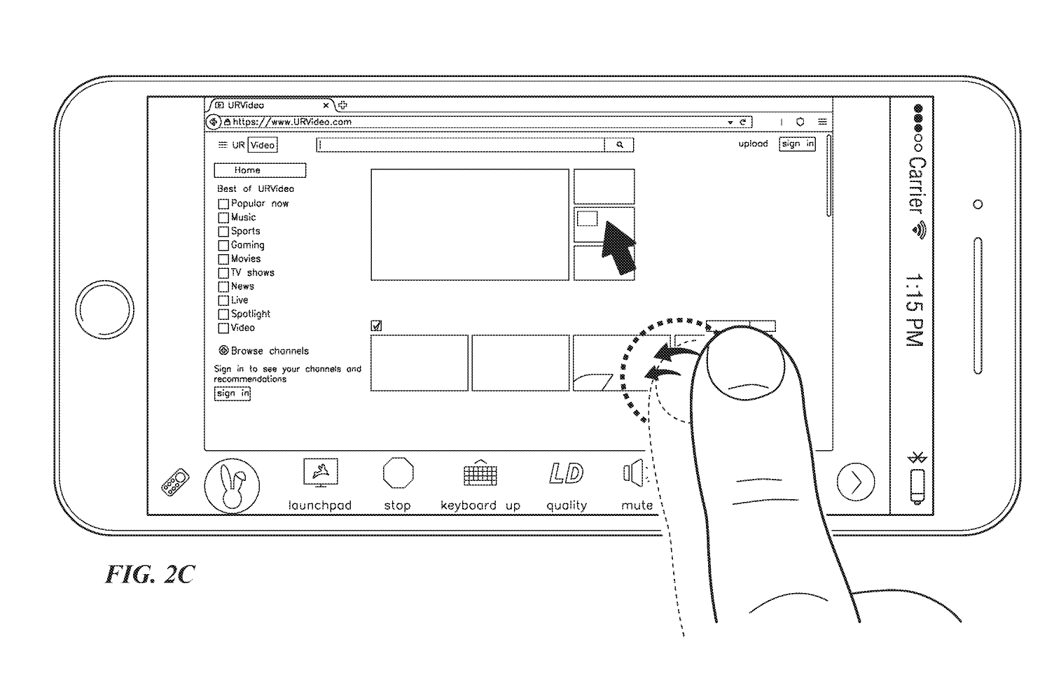

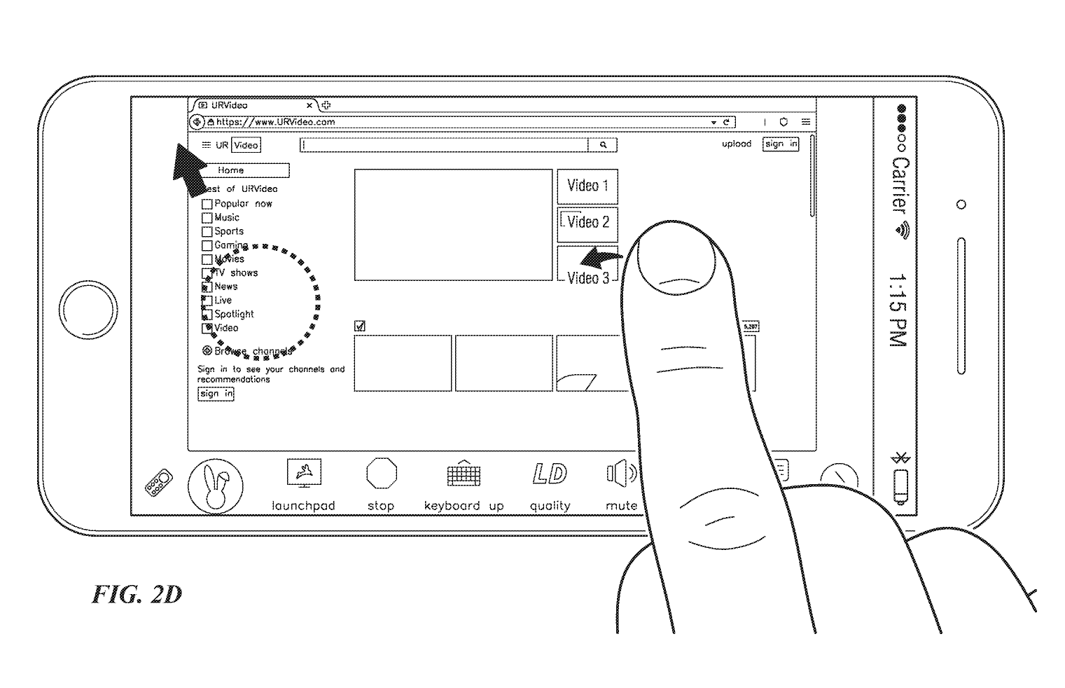

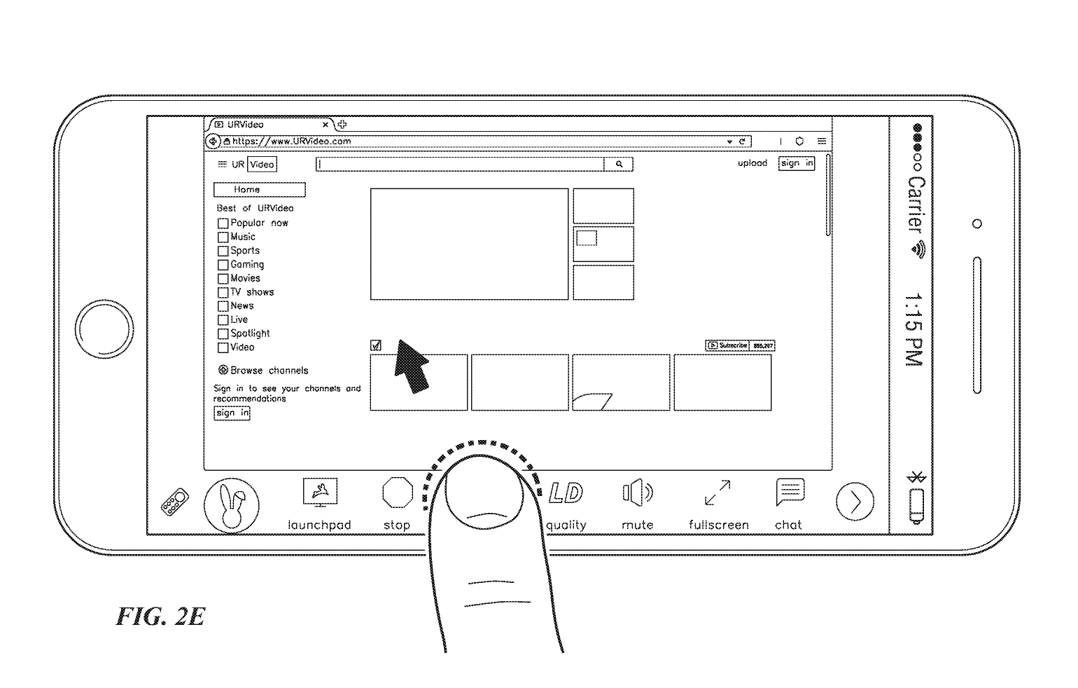

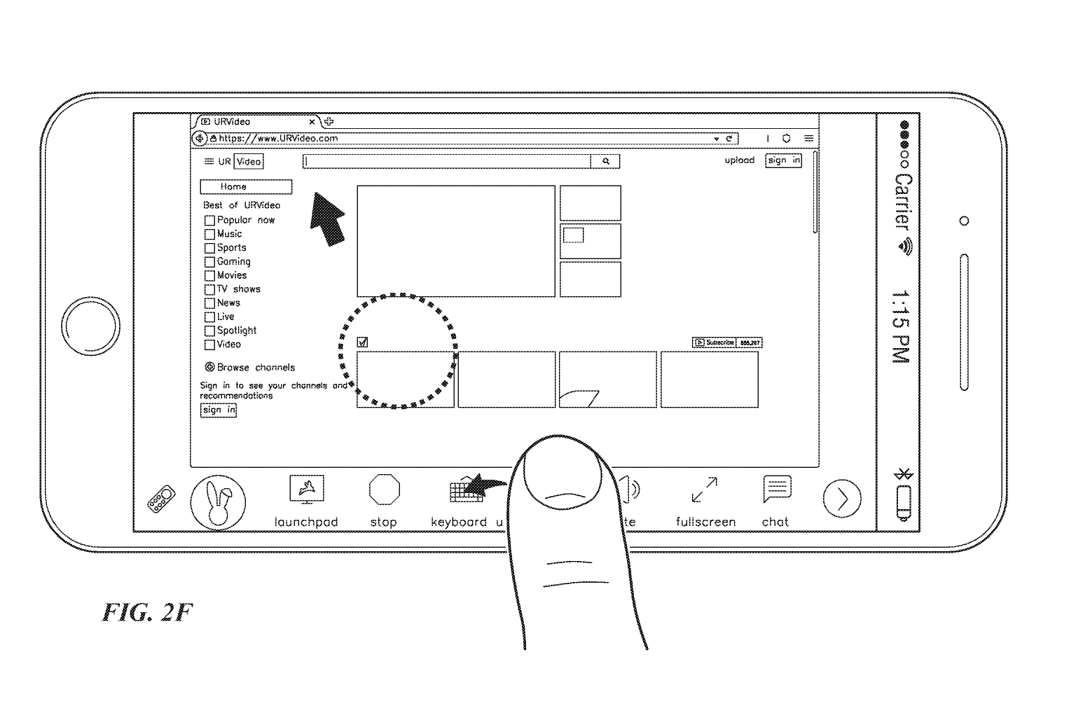

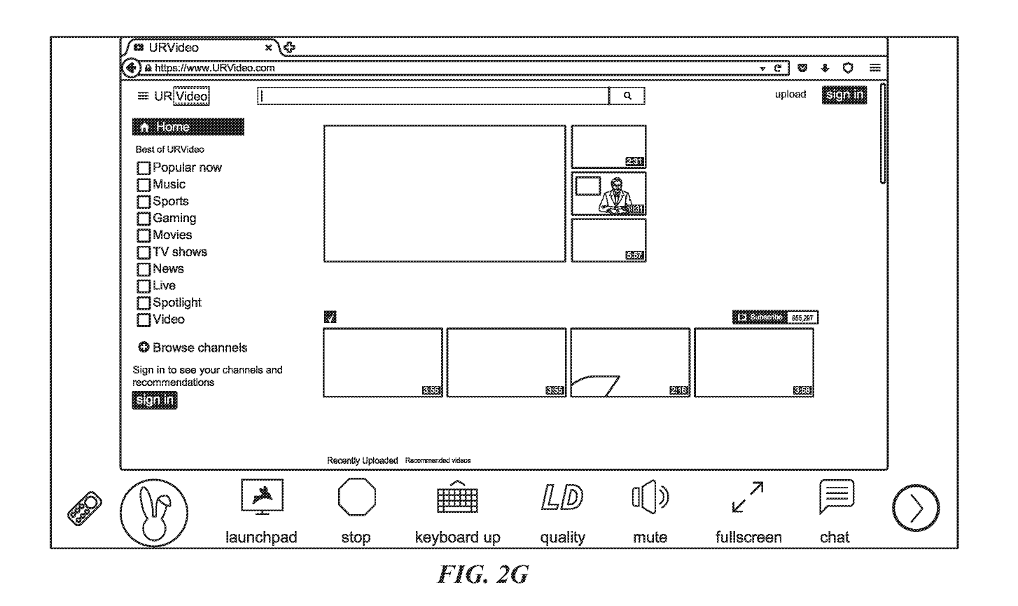

FIG. 2G illustrates an example UI. In particular embodiments, FIG. 2G may represent a remote device that has accessed a remote desktop and is displaying the content displayed on the remote device. In particular embodiments, the UI may include a navigation bar to allow a user to perform certain activities specific to that user's session and that user's device. In particular embodiments, the UI may include an avatar to represent the user, a home screen button, a stop button, a keyboard button, a streaming quality button, a mute button, a full screen button, a chat button, and any other suitable button for remotely controlling a desktop type device. In further embodiments, the UI may include a remote button to allow a user to pass the remote to different users. In further embodiments, passing the remote to a different user allows the user with the remote to control what is displayed on the user devices.

FIG. 2A illustrates an example of remotely controlling a mouse pointer from a user's touch device. In particular embodiments, a user may remotely move a mouse cursor on a remote desktop through a touch device. In particular embodiments, a user may remotely control the mouse pointer by a gesture including a single-touch interaction with the display screen. As an example and not by way of limitation, a single-touch interaction may include a user interaction in which only one finger of the user interacts with at least a portion of the display screen. In particular embodiments, as shown in FIG. 2A, the single-touch interaction may include touching the finger on the display screen of the electronic device. In particular embodiments, as shown in FIG. 2A, upon touching the display screen the mouse pointer may appear above the upper left hand corner of the finger. In further embodiments, the mouse pointer will clearly be visible to the user as the mouse pointer is spaced apart from the finger placement of the user such that the user's finger is not blocking view of the mouse pointer. In particular embodiments, upon replacing a finger on the display screen the mouse pointer may move to the new location of the finger location. In further embodiments, the system may draw a distinction between a user's finger being placed on the screen to control the mouse pointer compared to a user's tap on the screen to select an object on the screen's device. For example, a user may wish to tap on the screen to start a particular video. In this instance, the system may determine the user does not wish to use the mouse and because the user has quickly tapped on the screen and is not holding their finger on the screen, this may be determined to correspond to a tap. In this situation, the system may read the tap as indicating the user wishes to select what the user's finger has tapped. In further embodiments, upon a fingers contact with the screen, which does not indicate a tap, the system may determine the mouse pointer should be employed. For example, when a user touches the screen, and does not tap the screen, but instead leaves the finger on the screen display, the system will provide the mouse pointer for use.

In particular embodiments, the gesture may include a single-touch interaction for moving the finger location from one location to another location on the screen. For example, as shown in FIG. 2A, movement of the finger in the upward diagonal direction toward the right-side portion of the display screen may correspond to the mouse cursor moving at the same speed and keeping the same distance from the finger. In particular embodiments, as the finger moves the mouse pointer, the mouse pointer speed maintains the same speed as the user's finger. In particular embodiments, the mouse speed of the pointer may be fixed. For example, a user's finger may travel faster than the scrolling speed of the mouse pointer—in such case, the mouse pointer may lag behind the fingers movement.

In particular embodiments only the user holding the “remote control” is able to view or control the mouse cursor. In particular embodiments, all the users in the room are able to view the cursor. In particular embodiments, all the users in the room are able to control the cursor or multiple cursors (e.g., one cursor for each user).

FIG. 2B illustrates an example of remotely controlling a mouse pointer from a user's touch device. In particular embodiments, upon touching the display screen the mouse pointer may appear above the upper left hand corner of the finger. In further embodiments, the mouse pointer will clearly be visible to the user as the mouse pointer is spaced apart from the finger placement of the user such that the user's finger is not blocking view of the mouse pointer. In further embodiments, in addition to displaying the mouse pointer on the screen of the user's device, a second identifier is also displayed on the screen. For example, when remotely controlling a mouse pointer, the mouse pointer may have some lag or delay in the pointer's movement due to the fact that the mouse pointer is being remotely accessed (i.e., the mouse pointer corresponds to the location of the mouse pointer from a remote location). In particular embodiments, an icon, small circle, crosshair, or any other suitable type of image may be displayed on the user's touch device. In particular embodiments, the icon may be substantially the same size as the mouse pointer. In further embodiments, the icon may be substantially larger or smaller than the mouse pointer. In particular embodiments, the displayed icon is installed within the application or user's touch device. In further embodiments, the displayed icon is located substantially near the mouse pointer, however, if there is delay or lag, the mouse pointer will appear to follow the displayed icon. The displayed icon is displayed in real-time and because the icon is not being displayed from a remote screen, the icon will show no signs of delay or lag. In particular embodiments, the icon allows a more friendly user experience when the mouse pointer becomes laggy or delayed.

In particular embodiments, the icon may be permanently displayed on the device of the user who holds the “remote control” or who is remotely controlling the mouse pointer. In particular embodiments, the icon may displayed upon detecting display of the mouse pointer and upon the mouse pointer leaving the screen of the device the icon also is removed. In further embodiments, the icon may be displayed on the screen of the device upon detecting lag or delay between the user's movements on the screen and the remote mouse pointer. In further embodiments, the user may select to turn on or off the display of the icon.

FIG. 2C illustrates a gesture including a double single-touch interaction (or multi-touch interaction, but for a single finger) for selecting an object with the mouse pointer. In particular embodiments, a user may ‘click’ an object from a touch device connected to a remote desktop or device. In particular embodiments, when connected to a desktop remotely from a touch screen device the touch screen device may not be provided with a method for ‘clicking’ a mouse button. In particular embodiments, a user may need to ‘click’ a mouse in order to select certain content, move forward or back on a given website, open and close applications, or any other purpose for which a user may require the clicking of a mouse. In particular embodiments, a single-touch interaction with the screen display will act as a ‘click’ when using the mouse cursor remotely. For example, as shown in FIG. 2C, movement of the finger on the screen device may move the mouse pointer over a certain video. In particular embodiments, a user may then tap their finger in substantially the same area where their finger has just lifted from the screen display and such tap may correspond to a ‘click’ of the mouse.

In particular embodiments, a users tap on the screen display may correspond to multiple interactions with the remote desktop. For example, as shown in FIG. 2A, where a finger has moved the mouse pointer from one location to a second location, the finger has not lifted from the screen display after reaching the second location, the mouse pointer is currently over a ‘clickable’ object (as shown in FIG. 2C), the finger may lift off the screen device and tap in substantially the same area from where the finger has lifted and within a very brief time range from lifting the finger off the screen, such that the tap will correspond to a mouse ‘click.’

In particular embodiments, in order to register the mouse ‘click,’ the finger should tap in substantially the same location of where the finger has immediately lifted from the screen device. In particular embodiments, when the single-touch interaction occurs in a distance that is not substantially similar to the previous position of the finger, the tap will not correspond to a mouse ‘click’ and the system will treat the tap as either tapping on the particular area where the finger has been placed or that the mouse pointer location should be moved to the new location of the finger location.

In particular embodiments, in order to register the mouse ‘click,’ the finger tap may occur within a brief time period from lifting the finger off the screen device. For example, upon moving the mouse cursor over an object, if the finger lifts from the screen device for a period over roughly one second, when the finger returns to the screen device to tap the tap will not register a mouse ‘click.’ In particular embodiments, the finger tap may correspond to a mouse ‘click’ when the tap occurs in a short window of time from lifting the finger and tapping the finger. In further embodiments, when the finger tap does not occur within a certain time frame (e.g., the time frame may be set roughly to less than 0.25 seconds, 0.5 seconds, 1 second, 2 seconds, etc.), upon the device receiving the single-touch interaction on the screen device, the late tap may correspond to a user selecting the object with the late tap. In particular embodiments, lifting the touch and tapping within a short period of time may correspond to a mouse ‘click.’ In further embodiments, the mouse ‘click’ acts as a ‘click’ on the remote desktop (e.g., the tap is the equivalent of a mouse at the remote desktop ‘clicking’ the mouse button which may be selecting some object the mouse cursor of hovering over at the time of the click).

In particular embodiments, and with reference to FIG. 2C, the tap of the finger on the screen device may trigger the mouse cursor to ‘click.’ That is, even though the physical location of the tap is not over Video 2, it is the location of the mouse cursor that dictates where the ‘click’ occurs.

FIG. 2D illustrates a gesture including a single-touch interaction for selecting an object with the touch screen. For example, as shown in FIG. 2D, a gesture may include a single-touch interaction (i.e., a tap on the screen device) where such single-touch interaction corresponds to a selection of the content tapped. In particular embodiments, this single-touch interaction may not correspond to the location of the mouse cursor, but to the location of the touch of the finger. That is, while the mouse cursor may currently be located over a first content object, the tap of the finger may occur over a second content object and such tap may correspond to selecting the tapped content object.

In particular embodiments, the tap of the content object by a touch input may be differentiated from the ‘click’ of the mouse cursor based on the location of the tap. For example, if the touch input on the screen device is received at a location that is not substantially similar to where the last touch input was received on the screen device the tap may then correspond to a tap touch input as opposed to a mouse ‘click.’

In particular embodiments, the tap of the content object by a touch input may be differentiated from the ‘click’ of the mouse cursor based on the length of time. For example, if the last previously received touch input has been over a predetermined threshold (e.g., 0.25 seconds, 0.5 seconds, 1 second, 2 seconds, etc.) the next received touch input may correspond to a tap of the finger and not a ‘click’ of the mouse cursor.

In particular embodiments, a gesture including a single-touch interaction for selecting an object on the touch screen, where the selection is treated as a tap as a opposed to a tap corresponding to a mouse ‘click’, the tap functions the same as the mouse ‘click.’ For example, as shown in FIG. 2D, where after a certain time threshold a tap occurs on a content object (e.g., Video 3), the tap corresponds to a selecting of video 3. That is, the tap is the equivalent of a mouse ‘click,’ however the mouse need not be moved to location of the content object. As by way of another example, and also shown in FIG. 2D, if the tap where to occur in substantially a different position from the last recorded position on the screen device, for example, if the tap were to occur over Video 1, the tap over Video 1 would then correspond to selecting the content in Video 1.

In particular embodiments, and with reference to FIG. 2D, if the tap corresponds to a touch tap as opposed to a mouse ‘click,’ Video 3 would be the selected content object. In further embodiments, if the tap corresponds to a mouse ‘click,’ Video 2 would be the selected object. This feature allows a user to have multiple and natural touch screen options when selecting content on a touch device while controlling a non-touch screen remote device.

In particular embodiments, instead of a single tap, a double tap may be required to indicate a tap as opposed to a mouse ‘click’ tap. In particular embodiments, a mouse ‘click’ tap may be a double tap. In particular embodiments the distinction between a content tap and a mouse ‘click’ tap may be the pressure applied to the screen device. In particular embodiments a mouse ‘click’ tap may correspond to a light press where a content tap corresponds to a hard press or vise versa.

FIG. 2E illustrates a gesture including a single-touch interaction where the touch interaction extends over the menu buttons of the UI. In particular embodiments, as shown in FIG. 2E, there may be instances where content to be selected is located on the bottom of the touch screen. In particular embodiments, upon guiding the mouse cursor near the bottom of the screen the touch input may be located over the menu buttons. In particular embodiments, where the single-touch interaction has moved over the menu buttons while controlling the mouse cursor the movement over the menu buttons will not be considered a selection of that menu button. In particular embodiments, where a single-touch interaction is occurring on the screen device, the touch-interaction is continuing (i.e., their has been no break of screen contact), and where the single-touch interaction travels over the menu buttons, such interaction with the menu buttons will not correspond to a selection of such menu button.

In particular embodiments, and with reference to FIG. 2E, where the cursor is located on the bottom of the screen device and no touch interaction has occurred with the screen device the system must determine whether the touch interaction is selecting a menu option or attempting to move the mouse cursor. In particular embodiments, if the mouse cursor is located near the bottom of the screen and to move the mouse cursor the touch interaction must occur over the menu buttons the system may determine whether the user wishes to move the mouse cursor or select the menu buttons in any number of ways. In particular embodiments, where the single-touch interaction is a touch and hold, the system may determine the touch and hold interaction is to gain control of the mouse cursor as opposed to selecting a menu item. In further embodiments, where the single-touch interaction is a tap, the system may determine the tap is to select the tapped menu button. In particular embodiments, where the single-touch interaction is a hard press (as opposed to a light or soft press on the screen device), the system may determine the force of the hard press indicates control over the mouse cursor where the force of the light press indicates selection of the menu item, or vise versa.

FIG. 2F illustrates another example of a gesture including a single-touch interaction where a tap touch interactions occurs on the menu bar. In particular embodiments, where a tap touch interaction is located over a particular menu button the tapped menu button may be selected and the corresponding action may be taken. For example, if the tap where to occur over the ‘Mute’ button the device would mute all sound associated with running the application.

In particular embodiments, the gesture may include a multi-touch interaction of the user with the display screen that is associated with the device. As an example and not by way of limitation, a multi-touch interaction may include a user interaction in which at least two fingers of the user interacts with the display screen.

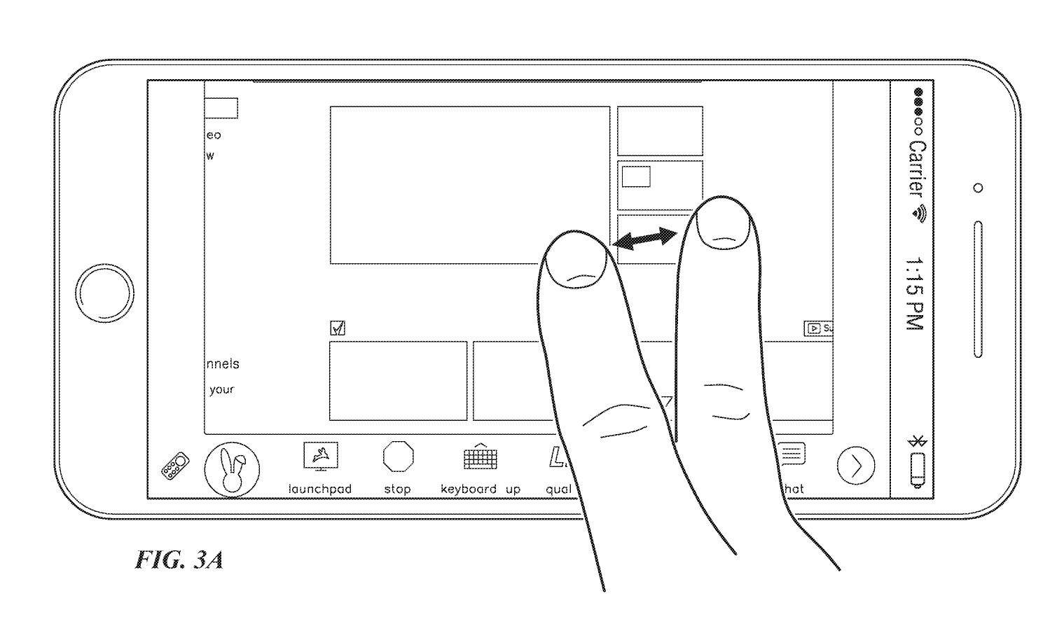

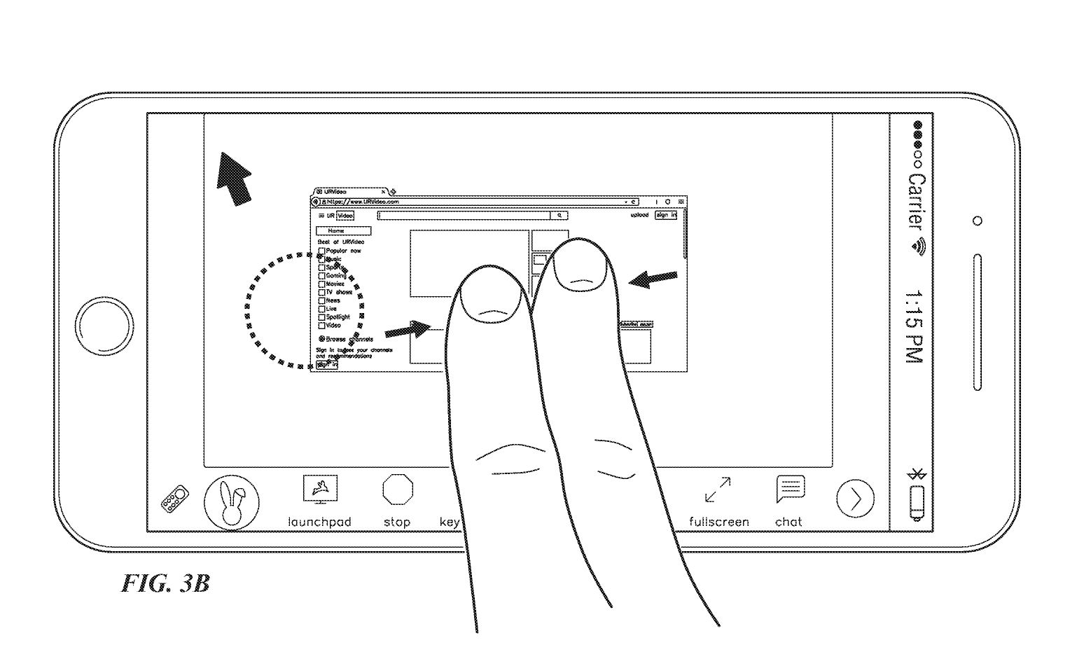

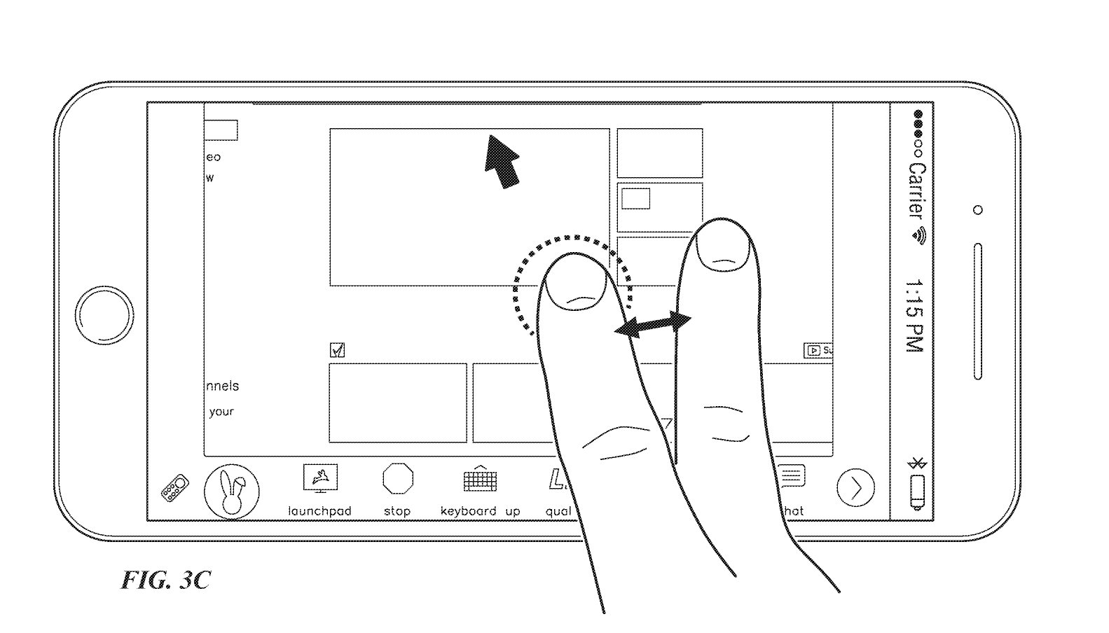

FIG. 3A illustrates an example of a multi-touch interaction for zooming. As an example and not by way of limitation, a multi-touch interaction may be used to either zoom in or zoom out. In particular embodiments, as shown in FIG. 3A, the multi-touch interaction may include a user touching two points on the screen and then moving the fingers apart from each other. As an example and not by way of limitation, moving the fingers apart from each other will result in zooming in. In particular embodiments, the user is zooming in on the content displayed on the users device even through the content is ultimately from the remote desktop.

FIG. 3B illustrates another example of a multi-touch interaction for zooming. As an example and not by way of limitation, as shown in FIG. 2B, the multi-touch interaction may include a user touching two points on the screen and then moving the fingers closer to each other. In particular embodiments, upon bringing two fingers closer to each other will result in zooming out. In particular embodiments, the remote desktop may display a website, video, or any visible content, and the user's touch screen device may zoom in or out on the remotely displayed content.

In particular embodiments, when a user zooms in or zooms out the zoom may be visible on that particular user's screen. In particular embodiments, when the user holding the “remote control” zooms in or zooms out the zoom may only be visible on that device. In particular embodiments, when the user holding the “remote control” zooms in our zooms out all of the participants in the group are able to view the zoom in or zoom out of the controlling user.

In particular embodiments, when the user with the remote control is zooming in or zooming out on specific content (i.e., content the system determines would be relevant for the other users in the room to view) the zoom may be visible to the other participants. For example, if the controlling user has loaded a page displaying a photo and the controlling user zooms in on the photo to explain or illustrate a certain feature of the photo the zoom will be applied to all of the user's devices. In further embodiments, where the controlling user is zooming in or zooming out over content that would be of no interest to the group (i.e., the controlling user is zooming in on the address bar to enter a different URL or attempting to click the ‘Back’ button in the web browser) the system will not apply to the zoom to all the users in the room. In further embodiments, the controlling user may have an option to apply the zoom all the user's in the room or to not apply the zoom. In further embodiments, the controlling user may have an option to select certain users to view the same zoom as the controlling user while not allowing other users to view the zoom.

In particular embodiments, a user (or controlling user) in a room is able to zoom in or out at any point while in the room and viewing the remote desktop display. For example, when the controlling user has started playing a video for the participants in the room, a user is able to zoom in or out while the video is playing.

FIG. 3C illustrates an example of a multi-touch interaction for zooming with use of the mouse cursor. In particular embodiments, a user is able to zoom and control the mouse cursor of a remote device using a touch device. In particular embodiments, a single-touch interaction may turn into a multi-touch interaction. For example, a user may be moving the mouse cursor from one location to another locations and then may need to zoom in or out on a particular object. In particular embodiments, the user need not lift the finger already touching the screen, the user may add the second finger and then zoom in or out accordingly.

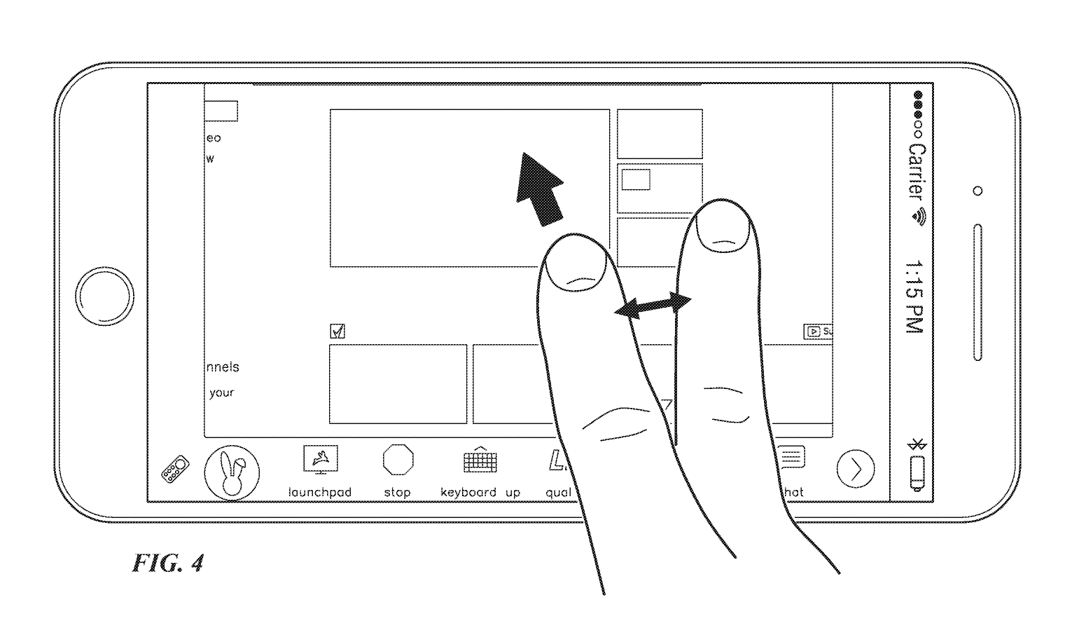

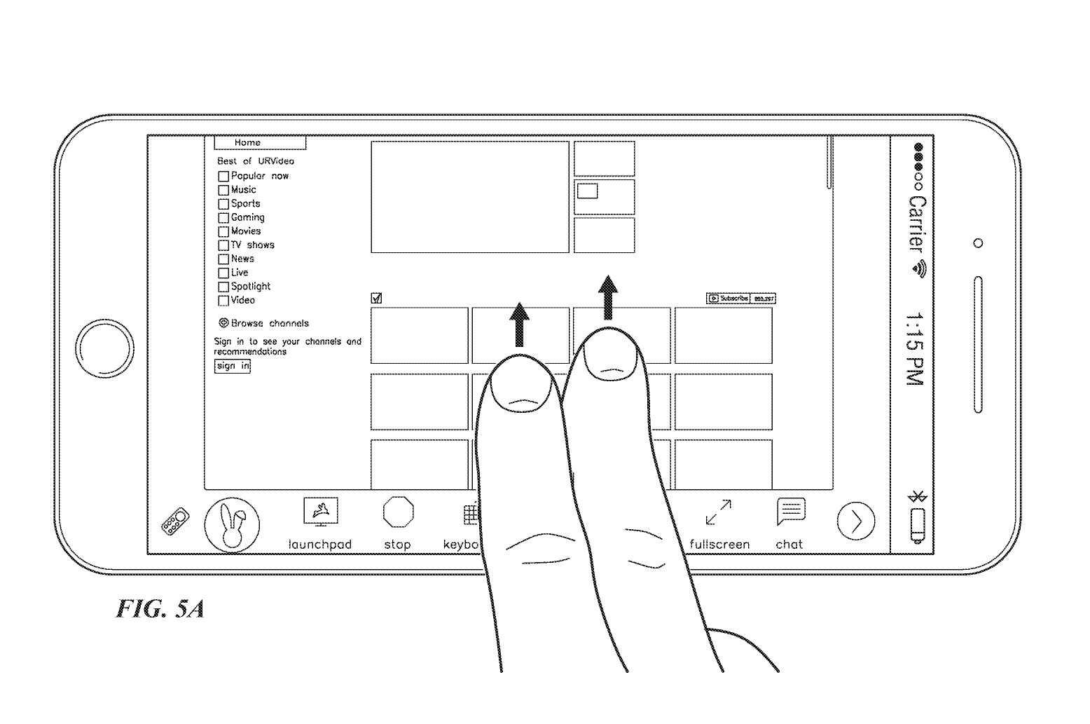

FIG. 4 illustrates an example of a multi-touch interaction for zooming and the effects on the mouse cursor. In particular embodiments, if the mouse cursor is displayed, when zooming in, the mouse cursor will simultaneously gain size in relation to the amount of zoom. In further embodiments, the mouse cursor will also move closer to the location of the touch input. In particular embodiments, it is necessary to move the mouse cursor closer to the touch input to ensure that while a user is zooming the mouse cursor does not fall out of view of the touch screen. In further embodiments, moving the mouse cursor closer to the location touch input provides more precision for the user in selecting objects with the mouse cursor.

In particular embodiments, and with reference to FIG. 4, as a user zooms in the mouse cursor size and the distance between the mouse cursor and the touch input will change relative to the amount of zoom. For example, as a user zooms in on content the mouse cursor size will continue to grow larger and larger to indicate that the user is zooming in. In further embodiments, as a user zooms in the mouse cursor will slowly move closer and closer to the location of the user's touch input.

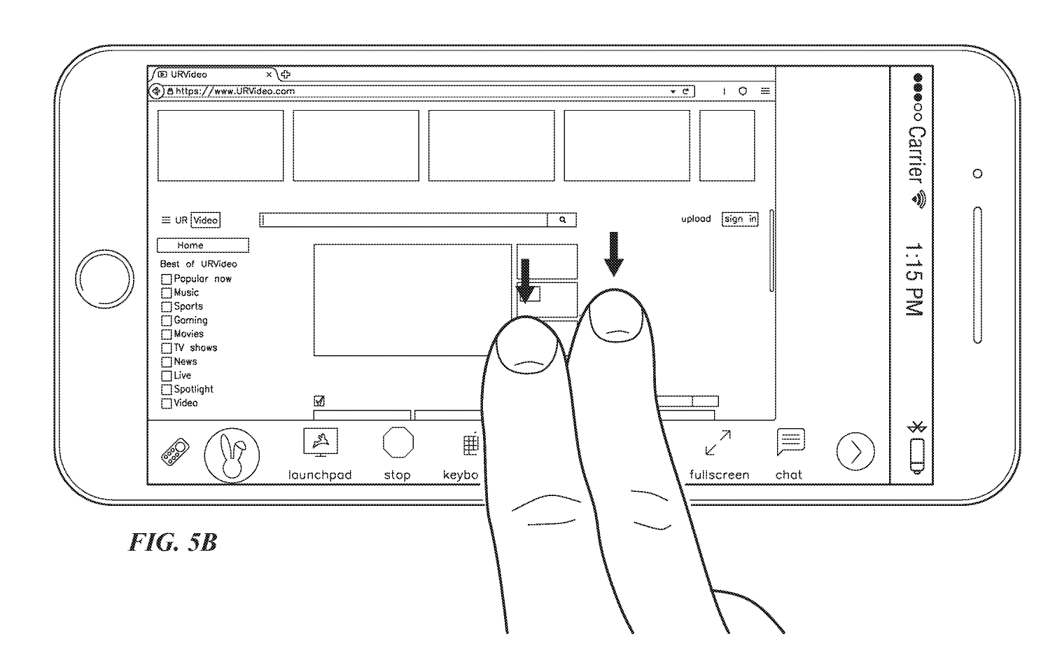

FIGS. 5A-B illustrate examples of a multi-touch interaction for scrolling. In particular embodiments, a user is able to scroll through content located on the remote desktop from their touch device by using two fingers and moving their two fingers in an upward or downward motion. In particular embodiments, and with reference to FIG. 5A, a user may scroll up using a multi-touch interaction by placing two fingers on the screen device and moving their fingers in a downward motion. In particular embodiments, the distance the fingers travel determines the speed of the scroll. For example, if the original touch inputs were located in the middle of the screen and ultimately moved down slightly, this would result in a slow scroll. If the original touch inputs were located in the top portion of the screen, however and moved down to the bottom of the device, because of the distance travelled (i.e., almost the maximum amount of length from top to bottom of the screen) the scroll speed would be fast.

In particular embodiments, the scrolling is only visible to the device of the user scrolling. In particular embodiments, when the controlling user scrolls all of the users in the room view the scrolling. In further embodiments, the scrolling is not visible to the other users in the room when the controlling user is scrolling. In further embodiments, the controlling user is able to select which participants in the room are able to view the actions of the controlling user (i.e., the users selected by the controlling user will be able to view the controlling user's scrolling, zooming, etc.)

In particular embodiments, the greater the force applied to the screen may determine the scroll speed. In particular embodiments, upon a user moving two fingers in the upward or downward direction, if the force applied to the screen device is strong the scroll speed will be increased as opposed to a light force, which would result in a slow speed.

This disclosure contemplate any suitable number of touch gestures associated with a touch screen device. One or more methods described herein illustrated the ability for a remote user, using a touch device, to control a remote desktop. In particular embodiments, the remote desktop may not be a touch device or capable of receiving touch input. In further embodiments, the methods described may allow a remote user to use a touch screen to control a device not traditionally used as a touch device.

One or more of the methods described herein allows for adapting a non-touch user-interface to operate as a user would expect a touch screen to act. That is, the methods described herein may relate to giving a user a natural transition to controlling a remote desktop through a touch screen device.

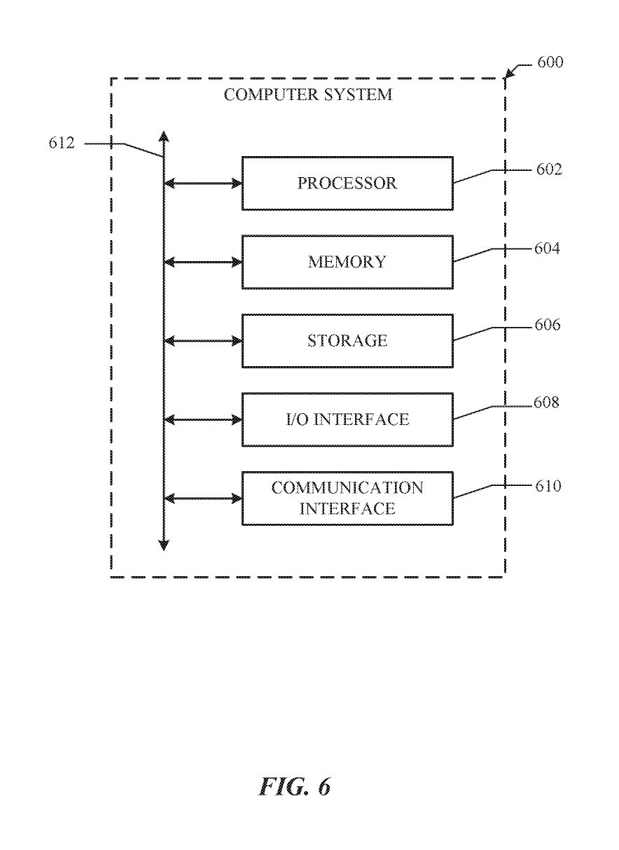

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more steps of one or more methods described or illustrated herein. In particular embodiments, one or more computer systems 600 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 504, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 508 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

What is claimed:

1. A method comprising:
receiving a request by an electronic device to access a computing device associated with a virtual-room at a virtual-room service system;
establishing a communication session between the electronic device and the computing device on behalf of the request;
receiving a user input at an electronic device, the user input comprising a touch input to control the computing device associated with the virtual room; and
sending a content to an interactive display screen of the electronic device based on the touch input.

2. The method of claim 1, wherein the computing device is configured to recognize orientation-specific user input when entered from any one of a plurality of orientations.

3. The method of claim 1,
wherein the touch input comprises a single-touch interaction, the single-touch interaction comprising an interaction of a finger of a user of the electronic device with at least one portion of the display screen.

4. The method of claim 3, wherein the sent content of the single-touch interaction is a mouse pointer associated with computing device.

5. The method of claim 4, wherein the mouse pointer appears at a distance from the user's single-touch interaction.

6. The method of claim 5, wherein the single-touch interaction comprises a swiping motion of the finger of the user in a particular direction, at a particular location, or a combination thereof, on the display screen.

7. The method of claim 6, wherein the single-touch interaction corresponds to moving the mouse point.

8. The method of claim 1, further comprising:
displaying an icon on the screen of the electronic device based on receiving the touch input.

9. The method of claim 8, wherein the icon is a small circle located substantially near the sent content.

10. The method of claim 1, wherein only a portion of the interactive display screen is associated with receiving the touch input.

11. The method of claim 1, wherein the touch input comprises a double single-touch interaction, the double single-touch interaction comprising:
an interaction of a finger of a user of the electronic device with at least one portion of the display screen;
a lifting of the finger;
and a second interaction of the finger within substantially the same portion of the display screen.

12. The method of claim 11, wherein the double single-touch interaction is associated with a click of a mouse pointer.

13. The method of claim 1, wherein the touch input comprises a multi-touch interaction, the multi-touch interaction comprising an interaction of at least two fingers of the user of the electronic device with at least one portion of the display screen.

14. The method of claim 13, wherein the multi-touch interaction comprises at least two fingers of the user moving a threshold distance along a central axis.

15. The method of claim 14, wherein the distance travelled of the at least two fingers determines the distance of an overall scroll.

16. The method of claim 1, wherein the touch input comprises a multi-touch interaction, the multi-touch interaction comprising an interaction of at least two fingers of the user of the electronic device with at least one portion of the display screen.

17. The method of claim 16, wherein the multi-touch interaction comprises at least two fingers of the user moving apart from each other.

18. The method of claim 16, wherein the multi-touch interaction comprises at least two fingers of the user moving towards each other.

19. One or more computer-readable non-transitory storage media embodying software that is operable when executed to:
receive a request by an electronic device to access a computing device associated with a virtual-room at a virtual-room service system;
establish a communication session between the electronic device and the computing device on behalf of the request;
receive a user input at an electronic device, the user input comprising a touch input to control the computing device associated with the virtual room; and
send a content to an interactive display screen of the electronic device based on the touch input.

20. A system comprising: one or more processors; and a non-transitory memory coupled to the processors comprising instructions executable by the processors, the processors operable when executing the instructions to:
receive a request by an electronic device to access a computing device associated with a virtual-room at a virtual-room service system;
establish a communication session between the electronic device and the computing device on behalf of the request;
receive a user input at an electronic device, the user input comprising a touch input to control the computing device associated with the virtual room; and
send a content to an interactive display screen of the electronic device based on the touch input.
